(19) United States
(12) Patent Application Publication
(10) Pub. No.: US 2025/0303859 A1
(43) Pub. Date: Oct. 2, 2025

(54) ON-VEHICLE DISPLAY DEVICE AND VEHICLE

(71) Applicant: TOYOTA JIDOSHA KABUSHIKI KAISHA, Toyota-shi Aichi-ken (JP)

(72) Inventors: Takahiro HIROTA, Nukata gun Aichi-ken (JP); Yuta SATO, Seto-shi Aichi-ken (JP)

(73) Assignee: TOYOTA JIDOSHA KABUSHIKI KAISHA, Toyota-shi Aichi-ken (JP)

(21) Appl. No.: 19/095,260

(22) Filed: Mar. 31, 2025

(30) Foreign Application Priority Data
Apr. 1, 2024 (JP) 2024-058534

(51) Int. Cl. B60K 35/22; B60K 35/21; B60K 35/81; G09G 3/20

(52) U.S. Cl. CPC B60K 35/22; B60K 35/213; B60K 35/81; G09G 3/2096; B60K 2360/349; G09G 2320/0238; G09G 2320/0242; G09G 2320/066; G09G 2320/0666; G09G 2320/0686; G09G 2380/10

(57) ABSTRACT

A CPU (processor) displays, on a panel, a background image selected by a user and displays, on the background image, a function-indicating image (such as a telltale or an indicator) representing vehicle information. Based on a color of the displayed function-indicating image and a color of an evaluation region being a boundary region around the function-indicating image in the background image, the CPU additionally displays, behind the function-indicating image, a patch image having a color different from the color of the evaluation region.

### CROSS REFERENCE TO RELATED APPLICATION

This application claims priority to Japanese Patent Application No. 2024-58534 filed on Apr. 1, 2024, which is incorporated herein by reference in its entirety including the specification, claims, drawings, and abstract.

### TECHNICAL FIELD

The present specification discloses an on-vehicle display device and a vehicle having the on-vehicle display device.

### BACKGROUND

On-vehicle display devices are disclosed in JP 2005-088673 A ('673 publication), JP 2007-526161 A ('161 publication), and WO 2009/034797 A ('797 publication). Such an on-vehicle display device is mounted on an instrument panel. The on-vehicle display device displays images of measuring instruments, such as a speedometer, for example. The on-vehicle display device allows a user to modify design or other properties of the images of the measuring instruments in accordance with their preferences.

In the '673 publication, when design of a measuring instrument image is changed, it is determined whether a color of an image supplied by a user is analogous to a color of a measuring instrument. When the color of the image supplied by the user is determined to be analogous to the color of the measuring instrument, the user is requested to change the color of the image.

In the '616 publication and the '797 publication, a parameter compensator is installed in the on-vehicle display device. When a setting value, such as a size, a position, or a color, of a measuring instrument image input by the user is found to cause deterioration in visibility of the image, the parameter compensator determines that the input setting value is ineligible. Then, the parameter compensator prompts the user to change the setting value. Alternatively, the parameter compensator automatically changes the setting value.

In the '161 publication, the measuring instrument image is contoured by lines of a prescribed color. Such contour lines improve visibility of the measuring instrument image.

The present specification discloses an on-vehicle display device which can provide increased flexibility in design of a background image while ensuring visibility of a function-indicating image representing vehicle information, and a vehicle in which the on-vehicle display device is installed.

### SUMMARY

This specification discloses an on-vehicle display device having a panel and a processor. The panel displays an image. The processor is configured to control image display on the panel. The processor displays on the panel a background image selected by a user. The processor further displays a function-indicating image representing vehicle information on the background image. Based on a color of the displayed function-indicating image and a color of an evaluation region being a boundary region around the function-indicating image in the background image, the processor additionally displays a patch image having a color different from a color of the evaluation region, behind the function-indicating image.

According to the above-described configuration, visibility of the function-indicating image can be ensured by the patch image, regardless of the color of the evaluation region in the background image.

In an aspect of this disclosure, a vehicle is disclosed. The vehicle has an on-vehicle display. The on-vehicle display has a panel and a processor. The panel displays an image. The processor is configured to control image display on the panel. The processor displays on the panel a background image selected by a user. The processor further displays a function-indicating image representing vehicle information on the background image. Based on a color of the displayed background image and a color of an evaluation region being a boundary region around the function-indicating image in the background image, the processor additionally displays a patch image having a color different from the color of the evaluation region, behind the function-indicating image.

In the thus-configured on-vehicle display device, the color of the evaluation region may be one of approximate colors previously defined in connection with the color of the displayed function-indicating image. In this case, the processor additionally displays the patch image behind the function-indicating image.

According to the above configuration, the patch image is additionally displayed when the color of the evaluation region is an approximate color of the color of the displayed function-indicating image.

Further, in the on-vehicle display device, there may be a case where the color of the evaluation region has RGB values close to those of the color of the displayed function-indicating image. In this case, the processor additionally displays the patch image behind the function-indicating image.

According to the above-described configuration, similarity between the color of the evaluation region and the color of the displayed function-indicating image is assessed based on the RGB values.

Still further, in the on-vehicle display device, there may be a case where at least one of a brightness difference and a color difference between the color of the evaluation region and the color of the displayed function-indicating image is smaller than a predetermined threshold value. In this case, the processor additionally displays the patch image behind the function-indicating image.

As will be described in detail below, the brightness difference and the color difference may be used in some cases as parameters for evaluating a chromatic contrast between a background color and a foreground color. As a result of determining whether or not to display the patch image based on the parameters, the patch image can be displayed in a situation where visibility is evaluated as being low on the basis of objective evidence.

Moreover, in the on-vehicle display device, the processor may set a complementary color of the color of the displayed function-indicating image as the color of the patch image.

In this way, it becomes possible to display the patch image which can yield clear chromatic contrast.

In the on-vehicle display device, the processor may set a black color as the color of the patch image.

According to the above configuration, the function-indicating image can be clearly displayed due to a black background around the function-indicating image.

Further, in the on-vehicle display device, the processor may display on the panel in a superimposed state a lower layer in which the background image is drawn, a middle layer in which the patch image is drawn, and an upper layer in which the function-indicating image is drawn.

According to the above-described configuration, processing to draw the background image, processing to draw the patch image, and processing to draw the function-indicating image can be performed independently of one another.

Still further, in the on-vehicle display device, the patch image may be a unicolor image of a solidly filled rectangle which can entirely cover the function-indicating image.

When configured as described above, even when slight layer misalignment occurs between the middle layer and the upper layer, the patch image is prevented from being entirely shifted out of the function-indicating image.

In the on-vehicle display device, the processor may display on the panel an image of a telltale as the function-indicating image.

According to the above-described configuration, visibility of the telltale (a warning lamp) can be ensured.

In the on-vehicle display device, once the patch image is additionally displayed behind the displayed function-indicating image, the processor may continuously display the patch image on the panel irrespective of a change in color of the evaluation region, until the displayed function-indicating image is hidden.

When the patch image is switched from a displayed state to a hidden state, in some cases the function-indicating image may be rendered relatively inconspicuous. However, so-called highlighting of the function-indicating image by the patch image can draw attention of a driver to an event (such as a shortage of fuel) referred to by the function-indicating image until the event is resolved.

Further, in the on-vehicle display device, the processor may change a brightness level of the patch image depending on the time of day.

The visibility of the function-indicating image can be ensured by displaying the patch image, although a combination of the patch image and the function-indicating image may be displayed in an overly obtrusive manner during the night, for example. In this case, overly obtrusive display of the function-indicating image can be alleviated by decreasing the brightness level of the patch image (intensity of light).

Still further, in the on-vehicle display device, the processor may apply a single patch image to a plurality of function-indicating images of the same color. In this case, the patch image is a unicolor image of a solidly filled rectangle. In addition, the processor defines an image size of the patch image such that the patch image can entirely cover a maximum function-indicating image among the plurality of function-indicating images of the same color.

According to the above-described configuration, the single patch image is displayed for all of the function-indicating images of the same color. This can reduce a memory load as compared to a configuration of the processor to individually specify patch images to the function-indicating images on a one-by-one basis.

The on-vehicle display device and the vehicle disclosed herein can increase flexibility in design of the background image while ensuring visibility of the function-indicating image representing vehicle information.

### BRIEF DESCRIPTION OF DRAWINGS

The patent or application file contains at least one drawing executed in color. Copies of this patent or patent application publication with color drawings will be provided by the Office upon request and payment of the necessary fee.

Embodiments of the present disclosure will be described based on the following figures, wherein:

FIG. 1 shows an example of a network configuration in a vehicle equipped with an on-vehicle display device according to an embodiment;

FIG. 2 shows an example of a panel in the on-vehicle display device;

FIG. 3A is a diagram for explaining a structure of image layers in the on-vehicle display device;

FIG. 3B is another diagram for explaining a structure of image layers in the on-vehicle display device;

FIG. 3C is another diagram for explaining a structure of image layers in the on-vehicle display device;

FIG. 4 shows an example of functional blocks of the on-vehicle display device;

FIG. 5 shows an example of a display determination table stored in a patch image database;

FIG. 6 shows an example of a determination flow to determine display of a patch image;

FIG. 7 is a diagram for explaining a method for setting an evaluation region;

FIG. 8 shows an example of display using a red background image prior to patch image processing;

FIG. 9 shows an example of display using the red background image after patch image processing;

FIG. 10 shows an example of display using a yellow background image prior to patch image processing; and

FIG. 11 shows an example of display using the yellow background image after patch image processing.

### DESCRIPTION OF EMBODIMENTS

### 1. Network Structure in Vehicle

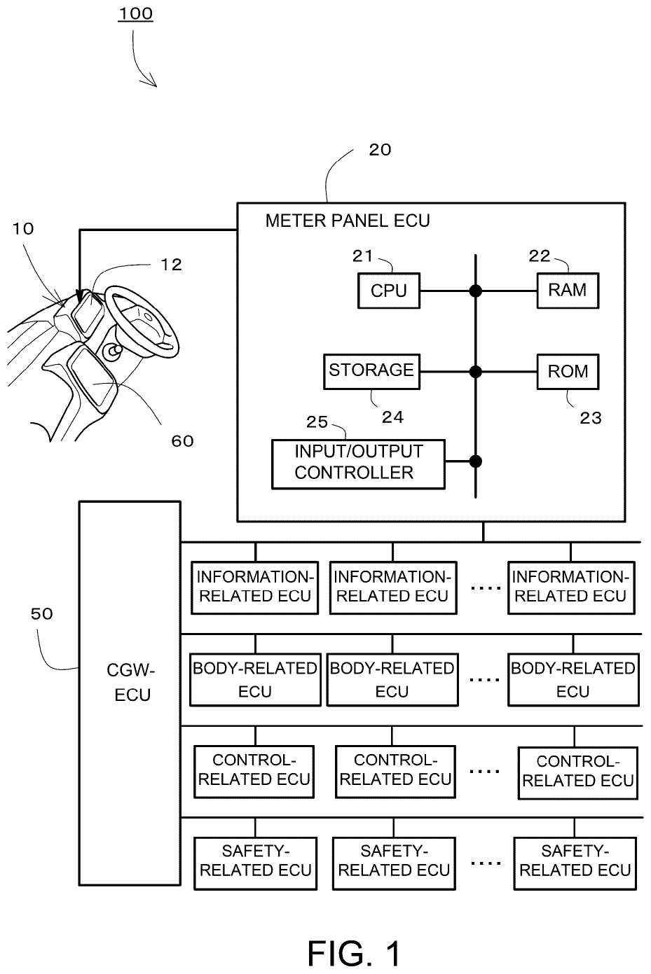

FIG. 1 shows an example of a network structure in a vehicle 100 according to an embodiment. The vehicle 100 is a hybrid electric vehicle, for example. In the vehicle 100, a plurality of Electric Control Units (ECUs) are installed. Each of the ECUs is implemented by a computer.

As can be seen from a representative illustration of a meter panel ECU 20 in FIG. 1, each of the ECUs incorporates a CPU 21, a RAM 22, a ROM 23, a storage 24, and an input/output controller 25.

The CPU 21, which is a central processing unit, is also referred to as a processor. The RAM 22 is a volatile memory for temporarily storing currently working data. The ROM 23 is a read memory which allows reading of data. The storage 24 is a read/write memory which allows reading and writing of data. The storage 24 is implemented by a Hard Disk Drive (HDD) or a Solid State Drive (SSD).

As illustrated in FIG. 1, a local area network (LAN) connecting the plurality of ECUs is built in the vehicle 100. The network is established, for example, in accordance with the Controller Area Network (CAN) being a communication protocol.

In the network illustrated in FIG. 1, the plurality of ECUs are divided into groups on a system-by-system basis. In the illustrated network, for example, a system-by-system bus is provided to each of a safely-related system, a control-related system, a body-related system, and an information-related system.

Among the plurality of ECUs, those performing air bag deployment control and collision safety control are connected to the safety-related system. ECUs for performing driving control are connected to the control-related system. For example, an ECU for controlling driving of an engine, an ECU for controlling driving of a rotary electric machine, and an ECU for controlling actuation of a brake, etc. are connected to the control-related system. An ECU for controlling lock/unlock of a door, an ECU for controlling an air conditioning system, and an ECU for controlling various lamps are connected to the body-related system.

An ECU for controlling an ETC (registered trademark) system, an ECU for controlling a navigation system, and an ECU for controlling an audiovisual system are connected to the information-related system. Further to the information-related system, the meter panel ECU 20 constituting a part of an on-vehicle display device according to the embodiment is connected. The meter panel ECU 20 will be explained in detail below.

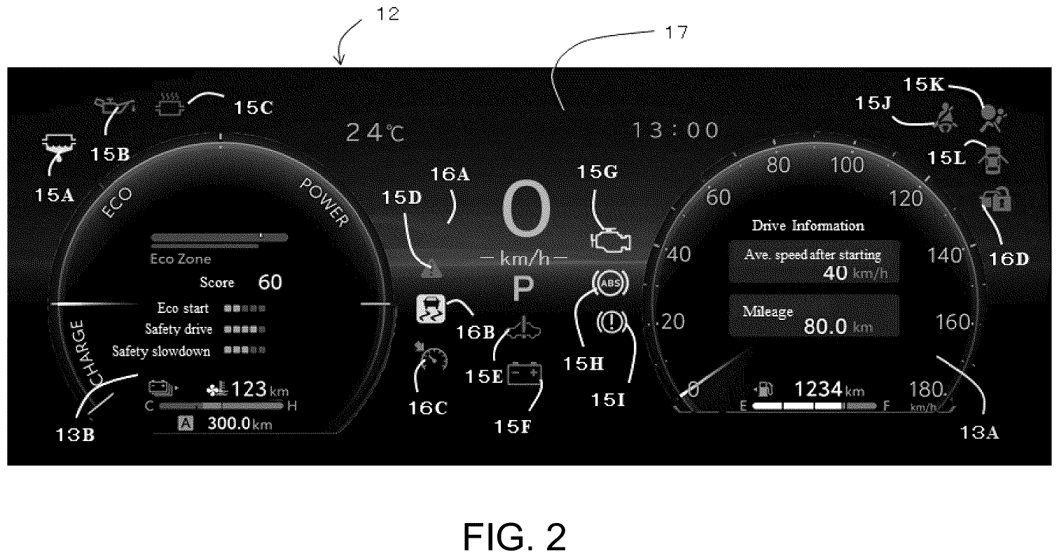

The information-related system, the body-related system, the control-related system, and the safety-related system are all connected to a central gateway ECU 50 (CGW-ECU). The central gateway ECU 50 mainly functions as a communication relay. That is, the central gateway ECU 50 relays communication between the ECUs. For example, when the safety-related ECU detects an abnormality in an air bag, an abnormal signal is transmitted from the safety-related ECU via the central gateway ECU 50 to the meter panel ECU 20. In response to the abnormal signal, the meter panel ECU 20 displays a telltale (warning lamp) 15K illustrated in FIG. 2.

### 2. On-Vehicle Display Device

FIG. 1 shows a display device mounted on the vehicle 100. For example, a combination meter 10 and a multimedia display 60 are installed in an instrument panel.

The multimedia display 60 is able to display a navigation image and an audiovisual image. The multimedia display 60 is a so-called touch pad on which information can be input. As will be described below, a user can select a background image 17 for the combination meter 10 by pushing a switch arranged on a steering wheel and operating the multimedia display 60.

The combination meter 10 includes a panel 12 and the meter panel ECU 20. The panel 12 is a display configured to display various images. The panel 12 is composed of an LCD panel or an LED panel, for example.

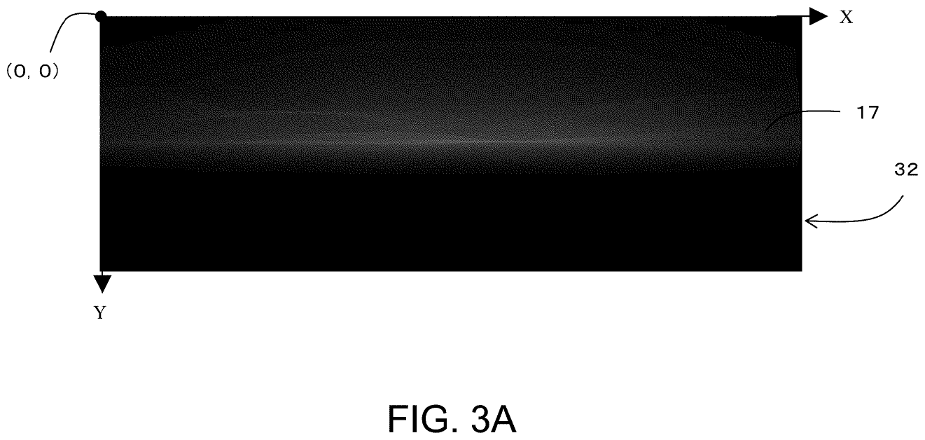

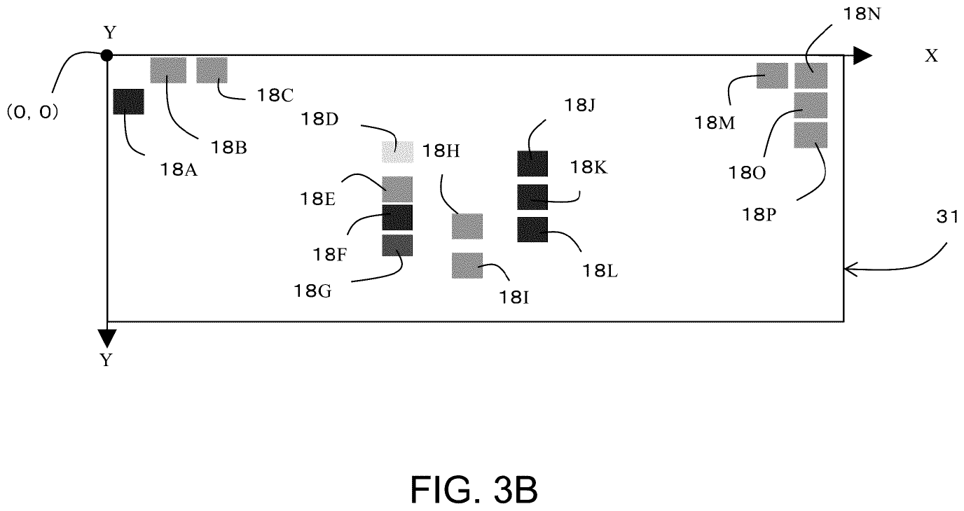

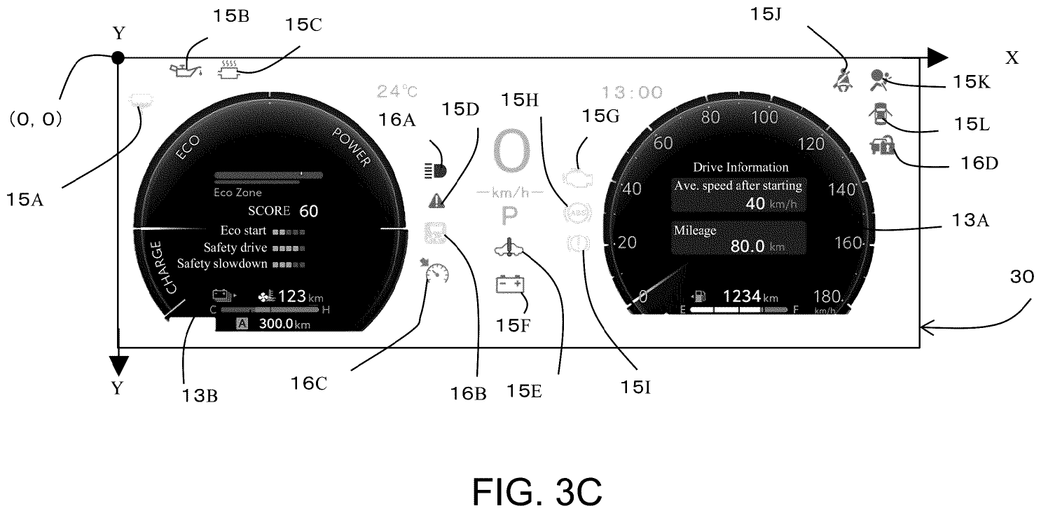

FIG. 2 shows displayed contents on the panel 12. The panel 12 displays function-indicating images, the background image 17, and below-described patch images 18A to 18P (see FIGS. 3A-3C).

Each of the function-indicating images is an image representing vehicle information. The function-indicating images include a speed plan image 13A, a battery information image 13B, telltales 15A to 15L (telltale images), and indicators 16A to 16D (indicator images).

The speed plan image 13A is a digital image mimicking an analog speedometer. The battery information image 13B shows the SOC of a battery and evaluations of so-called eco start and eco slowdown.

The telltales 15A to 15L are warning images notifying abnormalities in the vehicle. For example, the panel 12 displays the warning images described below. That is, a fuel filter warning (telltale 15A), a hydraulic pressure warning (telltale 15B), an exhaust sound warning (telltale 15C), a master warning (telltale 15D), an abnormality in a hybrid system (telltale 15E), and a charge warning (telltale 15F) are displayed on the panel 12. Further, an engine warning (15G), a brake assist warning (15H), a brake warning (15I), an unworn seat belt alarm (15J), an air bag warning (15K), and an incompletely-closed door warning (15L) are also displayed on the panel 12.

The indicators 16A to 16D represent operating states of vehicle systems. For example, the panel 12 displays an activated state of each of the systems for a high beam (16A), cruise control (16C), and security (16D). The panel 12 further displays a skidding state (16B) of the vehicle 100.

In the following description, the telltales 15A˜15L and the indicators 16A˜16D are collectively referred to as “signal images”.

The patch images 18A˜18P are displayed behind the signal images (telltales 15A˜15L and indicators 16A˜16D). Each of the patch images 18A˜18P is a small image piece relative to an image plane of the panel 12. The patch images 18A˜18P are rectangle images, for example. Further, the patch images 18A˜18P are solidly-filled unicolor images, for example.

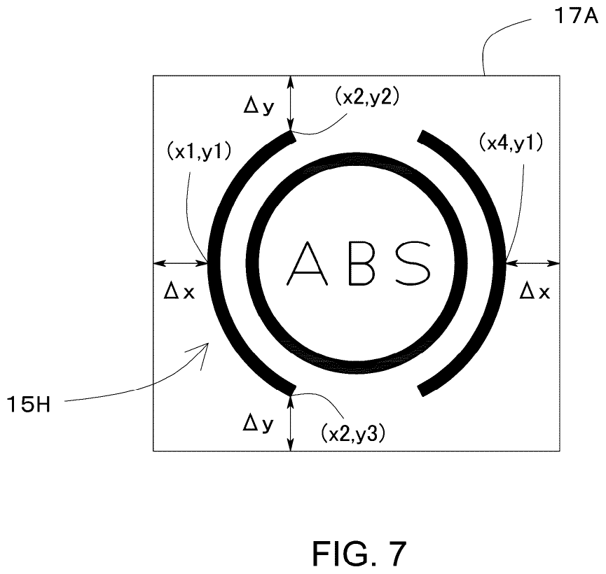

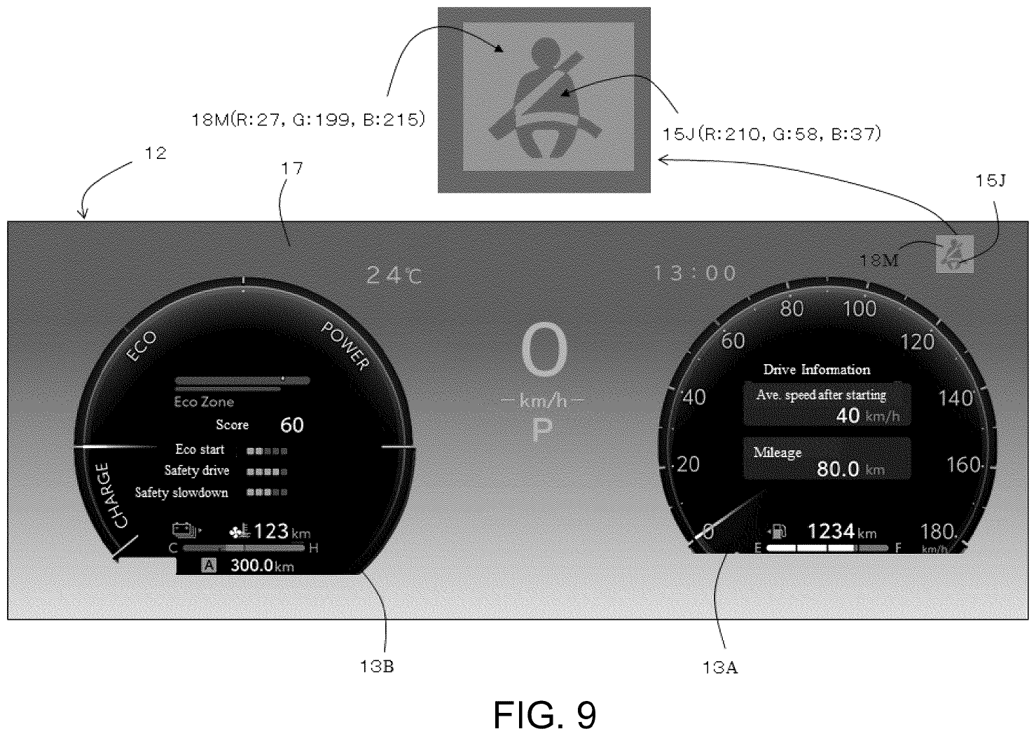

In FIG. 9, which will be referred to below, the patch image 18M is displayed behind the telltale 15J. The patch images 18A˜18P are sized to entirely cover corresponding signal images (telltales 15A˜15L and indicators 16A˜16D) displayed in front of the patch images 18A˜18P. For example, the patch images 18A˜18P are defined to be of the same size as an evaluation region 17A shown in FIG. 7 which will be referred to below.

In addition, display/nondisplay of the patch images 18A˜18P is determined based on a color of the signal image and a color of a background image around the signal image. A flow of the determination will be described in detail below. Hereinafter, unless any individual patch images 18A˜18P are specifically identified, the patch images 18A˜18P are simply referred to as the patch images 18.

Referring to FIGS. 3A-3C, the background image 17 is displayed behind the function-indicating images (the speed plan image 13A, the battery information image 13B, the telltales 15A˜15L, and the indicators 16A˜16D), and the patch images 18A˜18P. That is, the background image 17 is the hindmost image on the panel 12.

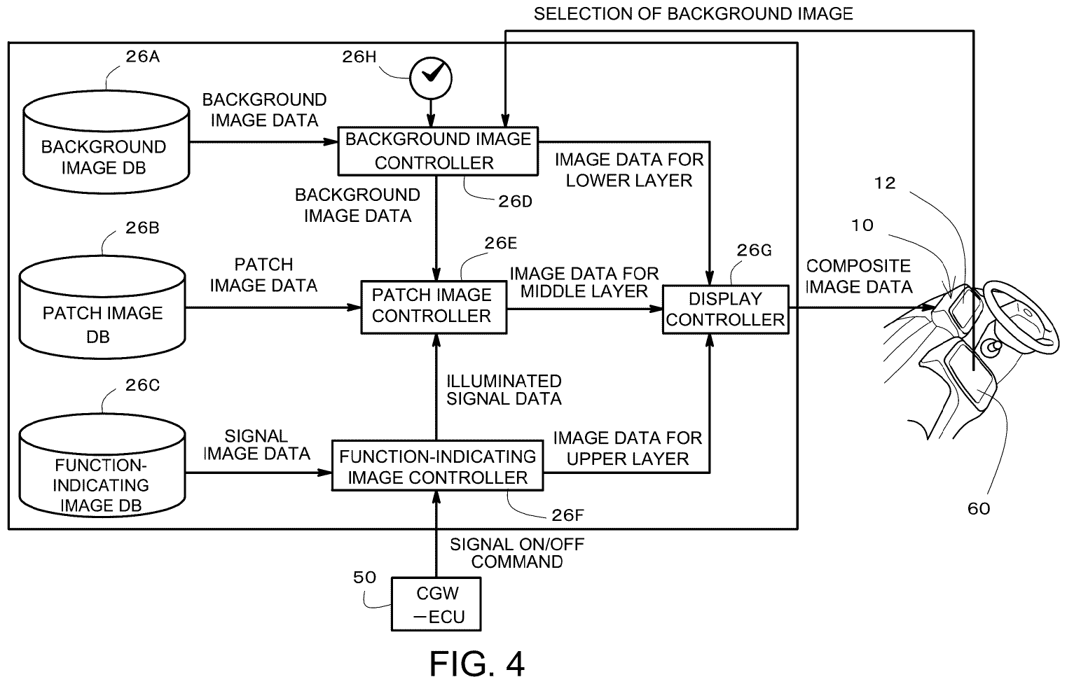

The background indicated by the background image 17 can be changed in design by a user, such as a driver. For example, the user pushes a switch mounted on the steering wheel or operates the multimedia display 60 to display a setting screen for the background image 17. Then, the multimedia display 60 shows various background images 17 stored in a background image database 26A (see FIG. 4). The user can change colors of a screen on the panel 12 by selecting a background image 17 having a different color, for example. The background images 17 selected by the user is displayed on the panel 12 (see FIG. 2).

For example, the background images 17 are unicolor gradient images. The unicolor gradient images include gradient images of various colors. The background image database 26A stores data of the background images 17 including the gradient images of various colors.

The background images 17 stored in the background image database 26A may include a patterned image whose color changes in a certain pattern depending on the time of day. For example, data of a background image 17 being a gradient image whose color changes based on the time of day, such as, for example, night, dawn, daytime, and dusk, is stored in the background image database 26A.

Here, the background images 17 stored in the background image database 26A include those having a color similar to the color of a function-indicating image (such as the speed plan image 13A, battery information image 13B, telltales 15A˜15L, indicators 16A˜16D). If the user selects such a background image 17 of the similar color, the background image 17 may decrease visibility of the function-indicating image, in particular, the signal image (the telltales 15A˜15L and the indicators 16A˜16D) that is superimposingly displayed on the background image 17. For example, “provisions with regard to the location and identification of hand controls (Regulation No. 121)” of the Economic Commission for Europe of the United Nations define requirements to ensure visibility of the telltales 15A˜15L and the indicators 16A˜16D. To satisfy the requirements under Regulation No. 121, the patch images 18A˜18P are inserted between the background image 17 and the function-indicating image as will be explained in detail below.

Referring to FIGS. 1 and 4, in the meter panel ECU 20, the CPU 21 (processor) executes a program stored in the ROM 23 or the storage 24. As a result, functional blocks illustrated in FIG. 4 are built in the meter panel ECU 20.

The meter panel ECU 20 includes, as storage units, the background image database 26A, a patch image database 26B, and a function-indicating image database 26C. The meter panel ECU 20 further includes, as arithmetic units, a background image controller 26D, a patch image controller 26E, a function-indicating image controller 26F, and a display controller 26G.

For example, the background image controller 26D, the patch image controller 26E, the function-indicating image controller 26F, and the display controller 26G are implemented by the CPU 21 (processor). That is, the CPU 21 (processor) controls image display on the panel 12.

The background image controller 26D draws the background image 17 on a lower layer 32 illustrated in FIG. 3A. The patch image controller 26E draws the patch images 18A˜18P on a middle layer 31. The function-indicating image controller 26F draws the function-indicating image on an upper layer 30. Because of such a multi-layer structure, a change in design in each layer can be performed independently of other layers.

For example, the upper layer 30, the middle layer 31, and the lower layer 32 are rectangular planes of the same size. In each of the layers, its upper left vertex is set to the origin (0, 0). Further, in each of the layers, the horizontal axis is defined as an X axis, and the vertical axis is defined as a Y axis. The origins (0, 0) of the upper layer 30, the middle layer 31, and the lower layer 32 coincide with each other. In addition, the upper layer 30, the middle layer 31, and the lower layer 32 are identical in scale of the X axis and the Y axis.

Here, when design of at least one of the upper layer 30, the middle layer 31, and the lower layer 32 is changed, for example, a scaling factor or a resolution of the layer may be changed in some cases. In such a case, so-called layer misalignment occurs.

In a case where the signal image is contoured by a border line, for example, an image of the border line is displayed on the middle layer 31. If the upper layer 30 and the middle layer 31 are superimposed in a slightly misaligned state, the border line is deviated from the signal image due to slight layer misalignment.

With this in view, the patch image 18 according to this embodiment is formed as a solidly filled rectangular image. Accordingly, even at the occurrence of slight layer misalignment, there can be prevented the situation where the patch image 18 is completely deviated from the signal image (telltales 15A˜15L or indicators 16A˜16D). Consequently, visibility of the signal image can be ensured by the patch image 18.

Concerning the background images 17, for example, an identification code of a background image 17 selected by the user is stored in the background image controller 26D. The background image controller 26D retrieves, from the background image database 26A, data of the background image 17 selected by the user, and draws the background image 17 on the lower layer 32. The data of the background image 17 includes, for example, RGB values specified at each coordinate.

Further, as described above, when the user selects the background image 17 being the color gradient image whose color changes depending on the time of day, the background image controller 26D retrieves a present time from a clock 26H and draws the background image with a color corresponding to a time zone of the retrieved present time.

Concerning the function-indicating images (the speed plan image 13A, battery information image 13B, telltales 15A˜15L, and indicators 16A˜16D) representing vehicle information, display positions of the function-indicating images are previously defined on the upper layer 30. For example, data on the function-indicating images are stored in the function-indicating image database 26C. The data on the function-indicating images include RGB values specified at each coordinate.

Colors of the telltales 15A˜15L and the indicators 16A˜16D are specified by International Agreements or the like. For example, World Wide Web Consortium (W3C) being an organization for standardization specifies colors of the telltales 15A˜15L and the indicators 16A˜16D. The telltales 15A˜15L and the indicators 16A˜16D are defined to have one of red, yellow, blue, and green colors based on the information to be indicated by the telltales 15A˜15L and the indicators 16A˜16D.

Among the function-indicating images, the speed plan image 13A and the battery information image 13B are always drawn (displayed) on the upper layer 30 so long as the drive system of the vehicle 100 is in the on state. On the other hand, the signal images (telltales 15A˜15L and indicators 16A˜16D) are switched between display/nondisplay in response to a command from the central gateway ECU 50.

On the middle layer 31, display positions of the patch images 18A˜18P are previously defined. The data of each of the patch images 18A˜18P include, for example, RGB values specified at each coordinate. Each of the patch images 18A˜18P is displayed at a location overlaid by a corresponding one of the signal images (telltales 15A˜15L and indicators 16A˜16D). For example, the coordinate of the center of the signal image matches the coordinate of the center of each of the patch images 18A˜18P. Color settings of the patch images 18A˜18P and a determination flow to determine display/nondisplay of the patch images 18A˜18P will be described below.

Referring to FIG. 4, the display controller 26G superimposes images in the upper layer 30, the middle layer 31, and the lower layer 32. For example, the display controller 26G retrieves image data of the lower layer 32 from the background image controller 26D, image data of the middle layer 31 from the patch image controller 26E, and image data of the upper layer 30 from the function-indicating image controller 26F.

The display controller 26G superimposes an image in the middle layer 31 on an image in the lower layer 32 to generate a composite image. Specifically, the display controller 26G refers to the RGB values at the same coordinate in the lower layer 32 and the middle layer 31. When at least one of an R value, a G value, and a B value in the RGB values of the middle layer 31 is nonzero (1 to 255), the display controller 26G sets the RGB values of the middle layer 31 as RGB values at the same coordinate in the composite image.

Subsequently, the display controller 26G superimposes an image in the upper layer 30 on the composite image of the superimposed lower and middle layers 32 and 31. This superimposing process is identical to the previous process of superimposing the images in the lower layer 32 and the middle layer 31, and its related description is not repeated.

The composite image in which the lower layer 32, the middle layer 31, and the top layer 30 are superimposed is displayed on the panel 12. For example, the display controller 26G converts image data of the composite image into a VGA signal and sends the VGA signal to the panel 12.

The panel 12 displays the composite image illustrated in FIG. 9. Specifically, the display controller 26G (processor) superimposes the function-indicating image (the telltale 15J, for example) on the background image 17 selected by the user, and displays on the panel 12 the composite image in which the patch image 18M is displayed between the background image 17 and the function-indicating image.

### 3. Settings for Patch Image

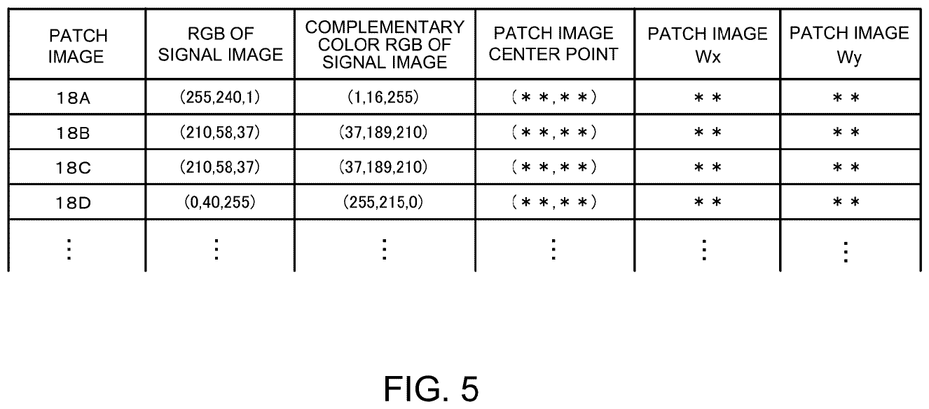

Referring to FIGS. 4 and 5, the patch image database 26B stores a display determination table (see FIG. 5) used as a basis for determining display/nondisplay of the patch images 18A˜18P. In the display determination table, the identification code of the patch image is recorded in association with RGB values of the signal image displayed in front of the patch image. The display determination table stores RGB values of a complementary color of the color of the signal image. The display determination table further stores, for each patch image, the center point, a width Wx in an X coordinate direction, and a width Wy in a Y coordinate direction.

The patch image 18 is, for example, a unicolor image of a solidly filled rectangle. The patch image 18 is sized to entirely cover the signal image that is displayed in front of the patch image itself. For example, a lateral width Wx and a vertical width Wy of the patch image 18 are defined such that the size of the patch image 18 is greater than that of the signal image which is layered above the patch image 18. The widths Wx and Wy are defined, for example, by adding predetermined margins to lateral and vertical widths of the signal image to be layered. In addition, the center point of the patch image 18 coincides with the center point of the signal image.

The color of the patch image 18 is, for example, a complementary color of the color of the signal image (function-indicating image) displayed in front of the patch image. A combination of values obtained by subtracting R, B, and G values of a particular color from the sum of the maximum value and the minimum value among the R, B, and G values are RGB values of the complementary color of the particular color.

In RGB values (10, 50, 200) of a signal image, for example, the sum of the maximum value and the minimum value is 210. The complemental color of the color having the RGB values (10, 50, 200) has RGB values (200, 160, 10)=(210−10, 210−50, 210−200).

The combination of a color and its complementary color is known as the most conspicuous combination of colors among all combinations of colors. When the complementary color of a color of the signal image is set to the patch image 18, a sufficient color difference is obtained between the signal image and the patch image. In other words, visibility of the signal image can be ensured.

Here, the color of the patch image 18 is not limited to the exact complementary color of a color of the signal image. For example, approximate colors of a color (exact complementary color) having RGB values found through the above-described calculation may be considered substantial complementary colors of the color, and such an approximate color may be set as the color of the patch image 18. A margin of ±10, for example, may be given to each of the calculated R, G, and B values of the complementary color. The RGB values of the patch image 18 are specified within a range of the calculated R, G, and B values with the added margin.

For example, there may be a case where the calculated complementary color does not satisfy (falls below) either one of thresholds of the brightness difference represented by below-described Equation (1) or the color difference represented by below-described Equation (2). In this case, at least one of the R value, the G value, and the B value is slightly adjusted within a range of ±10. As a result of the slight adjustment, a complementary color which yields both a brightness difference and a color difference matching or exceeding their thresholds is established as the color of the patch image 18.

### 4. Patch Image Display Determination Flow

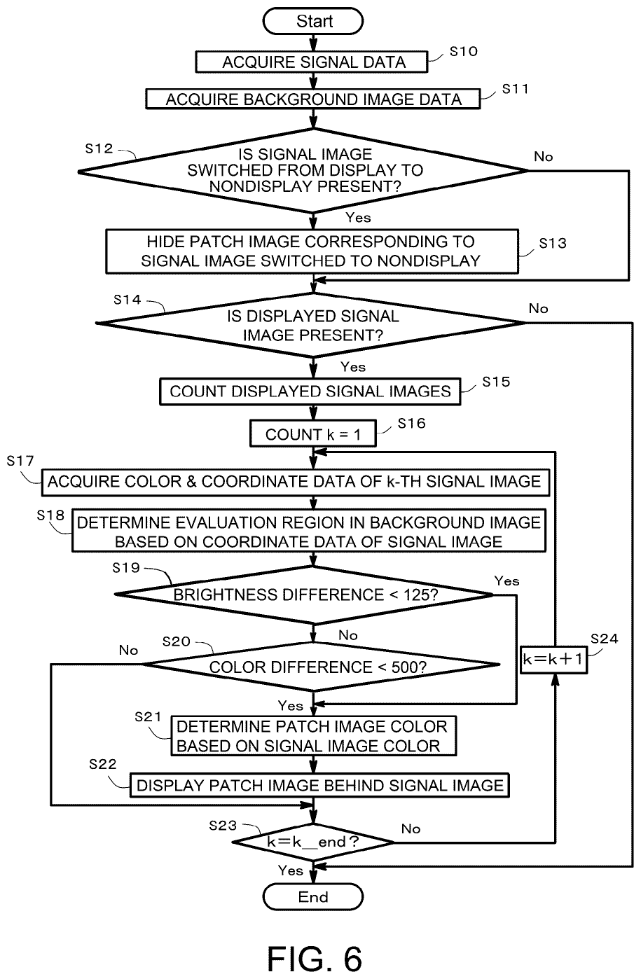

FIG. 6 shows a determination flow to determine display of the patch image. The determination flow is performed by the patch image controller 26E (see FIG. 4); i.e., by the CPU 21 (see FIG. 1).

For example, when new signal data is transmitted from the central gateway ECU 50 to the meter panel ECU 20, the determination flow shown in FIG. 6 is started. Alternatively, when the screen is updated with another background image 17, the determination flow of FIG. 6 is started. Here, the signal data contains an illuminate command (display command) and an extinguish command (nondisplay command) issued to the telltales and the indicators.

The patch image controller 26E acquires signal data from the central gateway ECU 50 (S10). The patch image controller 26E further acquires background image data from the background image controller 26D (S11).

Then, the patch image controller 26E determines the presence or absence of a signal image that is switched from a displayed state to a hidden state (S12). When there is no switched signal image, the process jumps to step S14. When the signal image switched from the displayed state to the hidden state is present, the patch image controller 26E hides the patch image placed behind the signal image switched to the hidden state (S13).

Next, the patch image controller 26E determines the presence or absence of a signal image being displayed (S14). When there is no displayed signal image on the panel 12, the determination flow is terminated. When one or more signal images being displayed are found on the panel 12, the patch image controller 26E counts the one or more signal images being displayed (S15).

Further, the patch image controller 26E determines the presence or absence of a patch image displayed for a first signal image having a count value (k=1) in the displayed signal images (S16). The patch image controller 26E acquires color data and coordinate data of a k-th signal image in the displayed signal images (S17). Then, the patch image controller 26E acquires, based on the coordinate data of the k-th signal image, an evaluation region in the background image 17 (S18).

The evaluation region as used herein denotes a boundary region around the signal image (function-indicating image) among regions of the background image 17. Referring to FIG. 7, for example, a boundary region around the telltale 15H being displayed is an evaluation region 17A. The evaluation region 17A has a rectangular shape.

The patch image controller 26E acquires, for example, coordinates (x1, y1) and (x4, y1) of both ends, in the X axis direction, of the telltale 15H and coordinates (x2, y2) and (x2, y3) of both ends, in the Y axis direction, of the telltale 15H. Further, the patch image controller 26E defines boundary lines of the evaluation region 17A at locations separated by predetermined margins Δx and Δy from the acquired coordinates.

The patch image controller 26E determines whether it is necessary to display the patch image 18, based on both a color of the signal image (function-indicating image) and a color of the evaluation region 17A. Specifically, when the color of the evaluation region 17A has RGB values close to those of the color of the signal image (function-indicating image), the patch image controller 26E determines that it is necessary to display the patch image 18.

Here, in a case where a plurality of colors are distributed in the evaluation region 17A, a color of the greatest display area in the evaluation region 17A is selected as a representative color, and the representative color is compared with the color of the signal image.

To quantitatively determine a close relationship in RGB values between two colors, the patch image controller 26E acquires a brightness difference between the signal image and the evaluation region 17A (S19). The brightness difference is acquired in accordance with the definition specified by the above-described W3C organization for standardization from the following Equation (1):

$$\begin{matrix}[ Equation 1 ] & \\ Brightness Difference = \frac{299 \times \vert {R}_{b -} {R}_{f} \vert + 587 \times \vert {G}_{b -} {G}_{f} \vert + 114 \times \vert {B}_{b} - {B}_{f} \vert}{1000} & ( 1 )\end{matrix}$$

Here, R_{f}, G_{f}, and B_{f} represent R, G, and B values of a fore image (i.e., signal image), respectively. R_{b}, G_{b}, and B_{b} represent R, G, and B values of a back image (i.e., evaluation region 17A), respectively. The W3C defines a threshold value of 125 for the brightness difference.

The patch image controller 26E determines whether the brightness difference between the signal image and the evaluation region 17A is smaller than the predetermined threshold value=125. When the brightness difference is smaller than the threshold value, the patch image controller 26E determines that it is necessary to display the patch image 18, and the flow moves to step S21.

When the brightness difference matches or exceeds the threshold value in step S19, the patch image controller 26E acquires a color difference between the signal image and the evaluation region 17A (S20). The color difference can be acquired based on the definition by the W3C organization for standardization from the following Equation (2).

$$\begin{matrix}[ Equation 2 ] & \\ Color Difference = \vert {R}_{b -} {R}_{f} \vert + \vert {G}_{b -} {G}_{f} \vert + \vert {B}_{b} - {B}_{f} \vert & ( 2 )\end{matrix}$$

The W3C defines a threshold value of 500 for the color difference. The patch image controller 26E determines whether the color difference between the signal image and the evaluation region 17A is smaller than the predetermined threshold value=500. When the color difference matches or exceeds the threshold value of 500 in step S20, the determination result shows, in combination with the previous result in step S19, that the brightness difference is greater than or equal to 125 and the color difference is greater than or equal to 500. Because such a combination of colors provides sufficiently high visibility, the patch image controller 26E determines that display of the patch image is unnecessary. That is, the flow moves to step S23 in which it is determined for the subsequent signal image whether or not to display a patch image.

When the color difference is smaller than the threshold value in step S20, it is determined that display of the patch image 18 is necessary, and the flow moves to step S21. The patch image controller 26E determines a color of the patch image 18 based on a color of the signal image (S21).

The patch image 18 is defined to be of a color different from that of the evaluation region 17A. For example, the patch image controller 26E refers to the display determination table (see FIG. 5) stored in the patch image database 26B. Then, the patch image controller 26E sets a complementary color (including the above-described substantially complementary color) of the signal image as the color of the patch image 18.

Next, the patch image controller 26E draws the patch image 18 in the middle layer 31 (see FIG. 3B) at coordinates corresponding to a position behind the signal image, and transmits the image in the middle layer 31 to the display controller 26G. The display controller 26G additionally displays the patch image 18 on a superimposed screen composed of the upper layer 30, the middle layer 31, and the lower layer 32 (S22).

Then, the patch image controller 26E determines whether the count of the signal image being a target of determination reaches the last value k_end (S23). When the count does not reach the last value k_end, the patch image controller 26E increments the count by one (S24) and returns operation to step S17. When the count reaches the last value k_end, the flow is terminated.

According to the above-described flow, the patch image 18 is additionally displayed behind the signal image when the color of the background image is close to the color of the signal image. In this way, visibility of the signal image can be ensured irrespective of the color of the background image.

Referring back to step S12, the patch image 18 is hidden when the signal image displayed in front of the patch image 18 is switched to the hidden state. That is, once the patch image 18 is displayed, the patch image 18 is continuously displayed even though the background image 17 is changed. In this way, extremely high visibility of the signal image can be maintained.

In other words, the extremely high visibility of the signal image can be obtained from an appropriate combination of colors of the signal image and the patch image 18. Therefore, if the patch image 18 is hidden, for example, in response to a change of the background image 17 to another background image 17, the combination of the other background image 17 and the signal image may decrease visibility of the signal image. This means that the effect of alerting the driver may be weakened.

To avoid such a decrease, once displayed, the patch image is continuously displayed until the signal image displayed in front of the patch image is hidden. This can ensure that the driver is alerted with a predetermined level of strength by the signal image.

It should be noted that because an appropriate combination of colors of the signal image and the patch image 18 can yield extremely high visibility of the signal image, the signal image may be rendered excessively conspicuous at nighttime, for example. For this reason, the patch image controller 26E may be configured to change the brightness (intensity of light) of the patch image 18 based on time of day. For example, during the nighttime, the patch image controller 26E lowers the brightness of the patch image 18 from that of the patch image 18 during the daytime.

### 5. Display Example of Patch Image

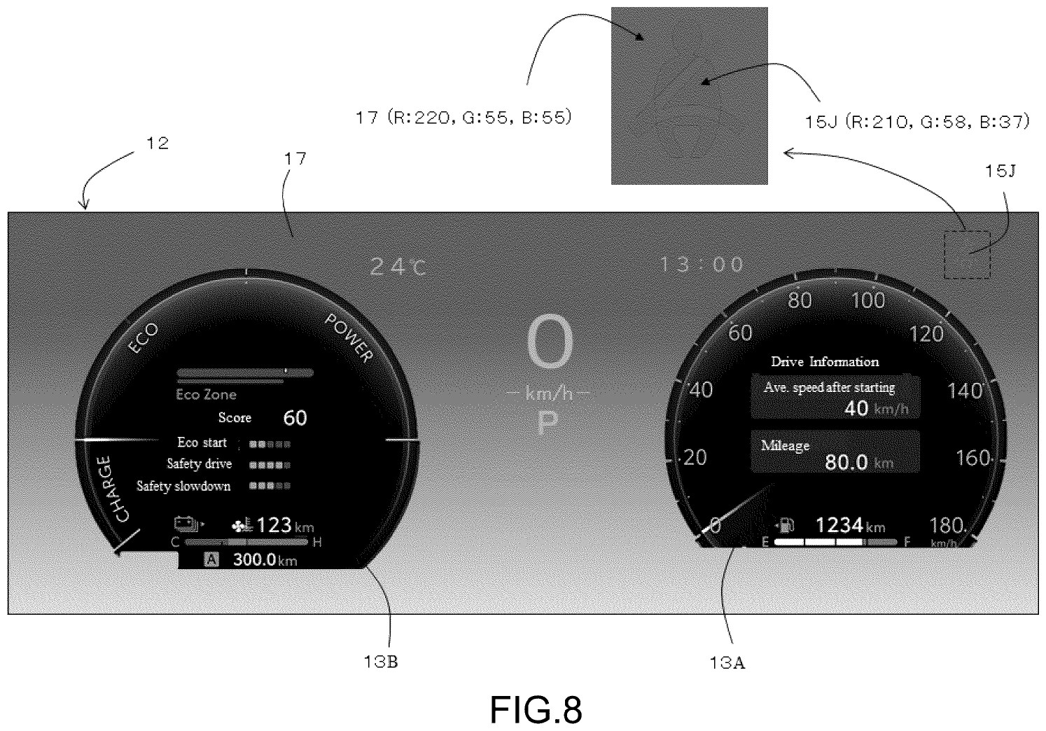

FIGS. 8 and 9 show Display Example (1) of the patch image. In FIG. 8, a gradient image of a red color (R=220, G=55, B=55) is displayed as the background image 17 on the panel 12. The telltale 15J being the signal image is displayed on the background image 17. The telltale 15J also has a red color (R=210, G=58, B=37). Here, a brightness difference between the background image 17 and the telltale 15J is 7, which is extremely lower than the threshold value of 125. Further, a color difference between them is 29, which is also extremely lower than the threshold value of 500.

In this case, the patch image 18M (see FIG. 9) is additionally displayed behind the telltale 15J according to the determination flow shown in FIG. 6. The patch image 18M is of a cyan color (R=27, G=199, B=215) that is a complementary color of red. The combination of the telltale 15 and the patch image 18M has a brightness difference of 158 (>125) and a color difference of 502 (>500). That is, both the brightness difference and the color difference match or exceed the threshold values, which can ensure visibility of the telltale 15J.

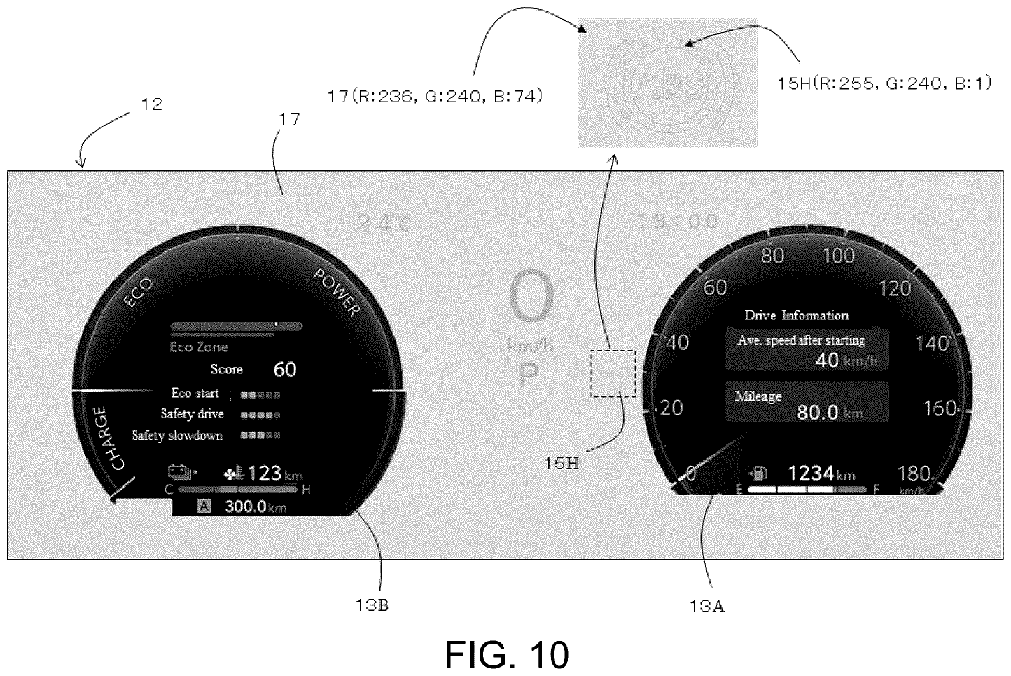

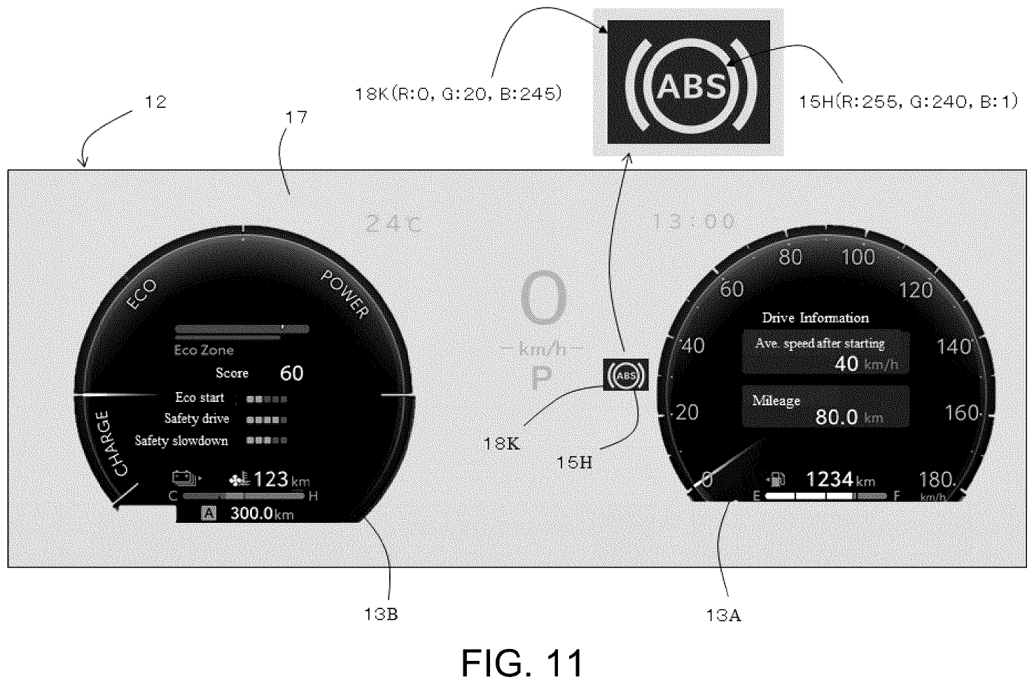

FIGS. 10 and 11 show Display Example (2) of the patch image. In FIG. 10, a yellow gradient image (R=236, B=240, B=74) is displayed as the background image 17 on the panel 12. The telltale 15H being the signal image is displayed on the background image 17. The telltale 15H also has a yellow color (R=255, G=240, B=1). Then, a brightness difference between the background image 17 and the telltale 15H is 14, which is extremely lower than the threshold value of 125, and a color difference is 92, which is also extremely lower than the threshold value of 500.

In this case, the patch image 18K (see FIG. 11) is additionally displayed behind the telltale 15H in accordance with the determination flow shown in FIG. 6. The patch image 18K is of a blue color (R=0, G=20, B=245) that is a complementary color of yellow. The combination of the telltale 15H and the patch image 18K has a brightness difference of 233 (>125) and a color difference of 719 (>500). That is, both of the brightness and color differences match or exceed the threshold values, which can ensure visibility of the telltale 15H.

As has been explained above, in the on-vehicle display device according to this embodiment, the patch image 18 is additionally displayed behind the function-indicating image when the background image 17 and the function-indicating image have similar colors. In other words, visibility of the function-indicating image can be ensured by the patch image 18 irrespective of the color of the evaluation region 17A in the background image 17. As a result, flexibility in design of the background image 17 can be increased.

### 6. Other Embodiments

### 6-1. Patch Image Display/Nondisplay Determination Technique

In steps S19 and S20 shown in FIG. 6, similarity is determined based on the brightness difference and the color difference between the signal image and the evaluation region 17A. Alternatively, the similarity may be determined in terms of approximate colors.

For example, approximate colors of a color are listed in commonly known color catalogs or the like. A booklet of standard paint color samples published by Japan Paint Manufacturers Association, for example, includes a list of approximate colors for predetermined colors.

Given this situation, the meter panel ECU 20 may store an approximate color list for each of the signal images. That is, approximate colors are predefined for each of the signal images.

Then, in place of steps S19 and S20 of FIG. 6, the CPU 21 (processor) in the meter panel ECU 20 determines whether a color of the evaluation region 17A matches one of the colors in the approximate color list predetermined for the signal image (function-indicating image) being displayed. When the color of the evaluation region 17A matches one of the colors in the approximate color list, the flow in FIG. 6 moves to step S21. Specifically, the CPU 21 (processor) additionally displays the patch image 18 behind the signal image (function-indicating image).

### 6-2. Color of Patch Image

In the above-described embodiment, the complementary color (including the substantially complementary colors) of a color of the signal image displayed in front of the patch image 18 is set as the color of the patch image 18. Alternatively, a black color (R=255, G=255, B=255) may be universally set as the color of the patch image 18 irrespective of the color of the signal image. As described above, the signal image has a predetermined brightness obtained from red, yellow, green, or blue, for example. When a black image having a brightness value of 0 is displayed behind the signal image, a high contrast ratio can be obtained.

### 6-3. Size of Patch Image

In the above-described embodiment, the size of the patch image 18 is defined based on the size of a function-indicating image (such as, for example, the telltale 15) that is displayed in front of the patch image 18. Alternatively, the patch image 18 may have a uniform size on a color-by-color basis. Specifically, the CPU 21 (processor) applies the same patch image to a plurality of function-indicating images of the same color.

In this case, the patch image controller 26E defines the image size of a patch image in such a manner that the patch image can cover the function-indicating image having the maximum size among the plurality of function-indicating images of the same color. For example, a cyan patch image 18 is displayed behind a red signal image. Therefore, the patch image controller 26E defines the size of the cyan patch image 18 so as to cover the largest signal image among red signal images.

### 6-4. On-Vehicle Display Device

In the above-described embodiment, the combination meter 10 is explained as a device which implements the on-vehicle display device. In place of the combination meter 10, a multimedia display 60 may implement the on-vehicle display device according to this embodiment. For example, the multimedia display 60 may display the function-indicating image, and additionally display the patch image 18 behind the function-indicating image as appropriate in a case where the background image is user selectable.

The present disclosure is not limited to the above-described embodiments, and may include all changes and modifications without departing from the technical scope or the essence of the present disclosure defined by the claims.

1. An on-vehicle display device, comprising:
a panel configured to display an image; and
a processor configured to control image display on the panel; wherein
the processor is further configured to
display a background image selected by a user on the panel, and display a function-indicating image representing vehicle information on the background image; and
based on a color of the displayed function-indicating image and a color of an evaluation region being a boundary region around the function-indicating image in the background image, additionally display a patch image having a color different from the color of the evaluation region, behind the function-indicating image.

2. A vehicle having an on-vehicle display,
wherein the on-vehicle display comprises:
a panel configured to display an image; and
a processor configured to control image display on the panel;
wherein the processor is further configured to
display a background image selected by a user on the panel, and display a function-indicating image representing vehicle information on the background image; and
based on a color of the displayed function-indicating image and a color of an evaluation region being a boundary region around the function-indicating image in the background image, additionally display a patch image having a color different from the color of the evaluation region, behind the function-indicating image.

3. The on-vehicle display device according to claim 1, wherein
the processor is configured to additionally display the patch image behind the function-indicating image when the color of the evaluation region is an approximate color previously defined in connection with the color of the displayed function-indicating image.

4. The on-vehicle display device according to claim 1, wherein
the processor is configured to additionally display the patch image behind the function-indicating image when RGB values of the color of the evaluation region are close to RGB values of the color of the displayed function-indicating image.

5. The on-vehicle display device according to claim 4, wherein
the processor is configured to additionally display the patch image behind the function-indicating image when at least one of a brightness difference and a color difference between the color of the evaluation region and the color of the displayed function-indicating image is smaller than a predetermined threshold value.

6. The on-vehicle display device according to claim 1, wherein
the processor is configured to set a complementary color of the color of the displayed function-indicating image as the color of the patch image.

7. The on-vehicle display device according to claim 1, wherein
the processor is configured to set a black color as the color of the patch image.

8. The on-vehicle display device according to claim 1, wherein
the processor is configured to superimposingly display, on the panel, a lower layer in which the background image is drawn, a middle layer in which the patch image is drawn, and an upper layer in which the function-indicating image is drawn.

9. The on-vehicle display device according to claim 8, wherein
the patch image is a unicolor image of a solidly filled rectangle that entirely covers the function-indicating image.

10. The on-vehicle display device according to claim 1, wherein
the processor is configured to display a telltale image as the function-indicating image on the panel.

11. The on-vehicle display device according to claim 1, wherein
the processor is configured to, after additionally displaying the patch image behind the displayed function-indicating image, continuously display the patch image on the panel irrespective of whether the color of the evaluation region is changed, until the displayed function-indicating image is hidden.

12. The on-vehicle display device according to claim 11, wherein
the processor is configured to change a level of brightness of the patch image based on a time of day.

13. The on-vehicle display device according to claim 1, wherein:
the processor is configured to apply a single patch image to a plurality of function-indicating images of the same color;
the patch image is a unicolor image of a solidly filled rectangle; and
the processor is further configured to define an image size of the patch image in such a manner that the patch image covers a largest function-indicating image among the plurality of function-indicating images of the same color.
